(19) United States
(12) Patent Application Publication
(10) Pub. No.: US 2010/0017182 A1
(43) Pub. Date: Jan. 21, 2010

(54) METHOD FOR CORONARY ARTERY DISEASE RISK ASSESSMENT

(76) Inventors: SZILARD VOROS, Atlanta, GA (US); Joseph Miller, Atlanta, GA (US)

Correspondence Address: KING & SPALDING, 1180 PEACHTREE STREET , NE, ATLANTA, GA, 30309-3521, US

(21) Appl. No.: 12/503,709

(22) Filed: Jul. 15, 2009

Related U.S. Application Data
(60) Provisional application No. 61/135,069, filed on Jul. 15, 2008.

(51) Int. Cl. G06G 7/60

(52) U.S. Cl. 703/11

(57) ABSTRACT

The present invention is directed to methods for atherosclerosis risk reduction including initial risk stratification, goal setting, and goal attainment for patients with, or at risk for, atherosclerosis. The present invention may be embodied in a computer implemented software product, the modules and sub-routines resident on a computer or hand held device, allowing a physician to determine the best strategy for coronary artery disease prevention based on such risk assessment values as Framingham score, genetic predisposition, biomarker levels and atherosclerosis imaging scores. The software product is supported by a backend database containing risk assessment value scores for a patient population of known clinical outcome. The database may reside in a memory unit, such as a hard drive, of the computer or hand held device, or may be accessed remotely in a distributed computer environment.

### CROSS-REFERENCE TO RELATED APPLICATIONS

This application claims the benefit of U.S. Provisional Patent Application No. 61/135,069, filed Jul. 15, 2008.

### FIELD OF INVENTION

The present invention relates to methods for atherosclerosis risk reduction, and more particularly, to highly individualized methods for risk stratification, goal setting and goal attainment for patients with, or subjects at risk for, atherosclerosis, preferably implemented as software modules on a computing device.

### BACKGROUND OF THE INVENTION

Atherosclerosis remains the leading cause of morbidity and mortality in the United States and worldwide. It is a complex disease, initiated by the deposition of lipoproteins in the arterial vessel wall and propagated by a secondary inflammatory process. Furthermore, endothelial dysfunction, aggravated by hypertension, diabetes and tobacco use, also significantly contributes to the process. Finally, rupture of the growing atherosclerotic plaque can accelerate the rate of disease progression and can culminate in fatal cardiovascular and cerebrovascular events.

The National Cholesterol Education Program (NCEP) has established clinical guidelines for risk stratification and treatment of patients with, or at risk for, atherosclerosis (Circulation 2002;106:3143-3421). The decision point to initiate treatment and set the primary therapeutic goals is stated in terms of LDL, or the patient's level of low density lipoprotein, a component of cholesterol (the so-called “bad cholesterol”). The NCEP guidelines have been updated over the years in accordance with new scientific and clinical findings. Adult Treatment Panel I (ATP I) established a strategy for primary prevention of coronary heart disease (CHD) in persons with high levels of LDL (160 mg/dL) or those with borderline-high LDL (130-159 mg/dL) and multiple (2+) risk factors. ATP II expanded the original focus to include intensive management of LDL cholesterol in persons with established CHD. ATP III is based on ATP I and II, but again expanded the focus to persons without established CHD who have multiple risk factors that constitute “CHD equivalents,” including diabetes and other clinical forms of atherosclerotic disease (peripheral arterial disease, abdominal aortic aneurysm, and symptomatic carotid artery disease).

Assessment of risk under ATP III begins with a fasting lipoprotein profile (total cholesterol, LDL cholesterol, high density lipoprotein (HDL) cholesterol and triglyceride). Determinants of risk apart from LDL levels are then considered. These include the presence or absence of CHD/CHD equivalents and the non-LDL major risk factors including hypertension, smoking, low HDL (the so-called “good cholesterol”), family history of early-onset CHD and age. On this basis, three categories of risk are identified: high risk (CHD and CHD risk equivalents), moderate risk (multiple (2+) risk factors) and low risk (zero to one risk factor).

The guidelines then establish an LDL lowering goal for each risk category: <100 mg/dL for persons at high risk, <130 mg/dl for persons at moderate risk and <160 mg/dl for persons at low risk. This LDL goal drives most treatment decisions going forward, with triglyceride levels and hypertensive status providing some additional direction.

The guidelines focus on two approaches for achieving lower LDL levels: life style change and drug therapy. Life style change emphasizes a reduction in saturated fat and cholesterol as well as moderate physical activity. The failure of these and other life style changes to modify LDL levels or the presence of high CHD risk levels prompts the use of drug therapy. Currently available drugs that impact lipoprotein metabolism include HMG CoA reductase inhibitors (statins) (e.g., lovastatin, pravastatin, fluvastatin atorvastatin, synvastatin and rosuvastatin), bile acid sequestrants (e.g., cholestyramine, colestipol, colesevelam), nicotinic acid, and fibric acid (e.g., gemfibrozil, fenofibrate clofibrates). The additional non-lipid risk factors (e.g., hypertension, diabetes) are also the focus of drug modification.

In general, the current guidelines essentially mandate that each individual is prescribed all pertinent medications that have been proven in clinical studies to be beneficial in that specific disease process, without taking into consideration the specific genetic and metabolic properties of a given individual. Polypharmacy is a common result, where a patient with atherosclerotic disease may be prescribed 1-2 medications for dyslipidemia, 1-3 medications for hypertension, 1-3 medications for diabetes and 1-2 medications for antiplatelet therapy.

This guideline-driven approach is accepted today as the “gold standard” for the practice of cardiovascular medicine, including risk assessment and treatment. Yet, a significant percentage of patients suffer CHD events in the absence of established risk factors for atherosclerosis and broad-based population risk estimations may provide little precision when applied to a given patient (Khot et al. J Am Med Assoc 2003; 290: 898-904; Nasir et al. Int J Cardiol 2006;110(2):129-36). The current treatment guidelines saturate patients with available drugs which can be costly and often ineffective. In general, most validated strategies result in approximately 30% relative risk reduction in individuals.

Efforts have been made to bring a more refined approach to diagnosis, risk stratification and treatment of atherosclerosis. Further analysis of the role of cholesterol subfractions has been one focus (Desai et al. Arter, Throm, & Vas Bio 2005;25:e110). U.S. Pat. No. 6,812,033 to Shewmake et al. discloses a method for identifying patients with normal NCEP lipid levels who are in need of treatment for cardiovascular disease via measurement of their LDL or HDL particle subclass levels. Abnormal LDL III a+b and/or HDL 2b values are taught as important for identifying potential cardiovascular disease that was likely missed due to a normal NCEP screen.

Serum biomarkers have been evaluated as independent markers of cardiovascular risk including cellular adhesion molecules, cytokines, proatherogenic enzymes, and C-reactive protein (CRP) (Blake et al. J Intern Med 2002; 252:283-294). Several studies have demonstrated an association between plasma lipoprotein-associated phospholipase A2 (Lp-PLA2) concentration and risk of subsequent cardiovascular events (Lanman et al. Prev Cardiol 2006; 9(3):138-43; Sabatine et al. Arter, Throm, & Vas Bio 2007; 27(11):2463-9).

U.S. Patent Application Publication No. 2007/0077614 to Wolfert et al. teaches a method for assessing risk of coronary vascular disease utilizing risk assessments from Lp-PLA2 in combination with other biomarkers. The invention includes Lp-PLA2 and CRP combined risk assessments as well as a method for assessing risk of coronary vascular disease in a patient with low to normal LDL levels utilizing both LDL and Lp-PLA2. The invention is also said to relate to the use of risk associated with Lp-PLA2, CRP, and LDL in combination and specific ranges thereof to predict coronary vascular disease. See also U.S. Patent Application Publication No. 2007/0292960 to Ridker.

Attention has also been directed to the use of imaging to categorize individuals into high or low risk for CAD, including invasive and non-invasive technologies (Davies et al. J Nuc Med 2004; 45(11); 1898-1907). Non-invasive technologies include ultrasound, computed tomography (CT) and magnetic resonance imaging (MRI). Electron beam CT (EBCT) is used to quantify the amount of coronary artery calcification (CAC), which has been shown to predict cardiovascular events independently. Magnetic resonance imaging provides an image of the morphology and extent of atherosclerotic plaques. Invasive technologies include x-ray angiography, intravascular ultrasound, angioscopy, and intravascular thermography. Yet even a “normal” x-ray angiography, the imaging “gold standard”, cannot be interpreted as indicating an absence of atherosclerosis (Davies et al.).

U.S. Patent Application Publication No. 2004/0133100 to Naghavi et al. discloses a system and method for using data generated during a scan of a patient to aid in assessment of coronary risk based upon coronary calcification. CT-generated calcification data is stored and later analyzed to determine a distribution of calcification in the patient. This analysis is then used in an estimation of the patient's risk for cardiovascular disease.

U.S. Pat. No. 7,340,083 to Yuan et al. discloses a method and system for atherosclerosis risk scoring using one or more images of cross-sections of the artery or other vessel of interest to identify and locate components of the atherosclerotic deposit, including any hemorrhage, necrotic core, and calcification, and to determine the status and composition of the fibrous cap. In one embodiment, high resolution MRI images are utilized, although other imaging modalities are taught as suitable. A scoring system is applied that accounts for the presence of these components and more heavily weights the presence of these components in the juxtaluminal portion of the deposit. The status of the fibrous cap (intact or ruptured) and the composition of the fibrous cap (collagen or mixed tissue) are also incorporated into a final atherosclerosis risk score.

Efforts have been made to compare these independent risk assessment methodologies to traditional risk factor analysis under NCEP guidelines and Framingham risk assessments (a related but independent methodology of determining 10-year CAD risk), as well as to utilize certain methodologies in combination to provide more comprehensive risk assessment. Michos et al. teaches that coronary artery calcium (CAC) may provide incremental value to Framingham risk equations in identifying asymptomatic women who will benefit from targeted preventative measures (Michos et al. Athero 2006;184(1):201-6). Pletcher et al. discloses a use of CAC scores in combination with conventional risk factor data as predictors of coronary heart disease (Pletcher et al. BMC Med 2004; 2:31). Nasir et al. reported an association between family history of premature CHD and the presence of CAC (advanced or otherwise) in the MESA (Multi Ethnic Study of Atherosclerosis) study (Nasir et al. Circ 2007; 1 16(6):619-26).

U.S. Patent Application Publication No. 2005/0261558 to Eaton et al. teaches a disease risk evaluation and education tool, preferably implemented in logic on a computing device such as a Personal Digital Assistant, which permits a user to input patient-specific data relevant to evaluating that patient's risk for a particular disease, e.g., coronary heart disease. The tool's logic calculates the equivalent age of the patient, based on the Framingham data set and on the input data, and presents one or more treatment recommendations.

U.S. Pat. No. 7,306,562 to Bykal teaches a medical risk assessment method and computer program product resident on a computer or a hand-held device that allows a clinician to determine the best strategy for primary and secondary cardiovascular disease prevention utilizing current guidelines and published medical literature. The computer program product evaluates a number of risk factors to determine specific recommendations for an individual patient, including Framingham risk scoring (FRS), pertinent medical history, individual lipid panel and advanced lipoprotein profiling, patient laboratory test results, and published literature on the effects of anti-lipid medicines on plasma concentration and/or composition of lipoprotein molecules and clinical outcomes. The risk assessment method establishes a cardiovascular treatment therapy strategy for a patient by determining a cardiac risk classification group, determining a cardiovascular treatment therapy based on the patient's lipoprotein profile and the patient's cardiac group risk classification, and presenting the cardiovascular treatment therapy for the patient to a medical practitioner on a patient evaluation display.

However, despite the clear desire in the art, the need remains for a truly individualized approach to atherosclerotic risk management that integrates a wide range of genomic and phenotypic information to provide an optimal approach to risk stratification, goal setting, and goal attainment.

It is thus an object of the present invention to provide a multidimensional approach using genetic factors, advanced lipoprotein analysis, biomarkers, and atherosclerotic imaging in combination to refine the process of risk stratification for patients with, or at risk of, atherosclerosis.

It is a further object of the present invention to provide that same multidimensional approach to clinical goal setting for individual patients with, or at risk of, atherosclerosis.

It is a still further object of the present invention to bring this novel, multidimensional approach to goal attainment and monitoring for individual patients.

### SUMMARY OF INVENTION

The present invention is directed to highly individualized methods for atherosclerosis risk reduction. In contrast to current guidelines, which depend heavily on LDL-levels, the methods of the present invention provide a multidimensional approach to risk-stratification, goal-setting and goal attainment that utilizes genetic factors, advanced lipoprotein analysis, biomarkers, and atherosclerotic imaging in unique combinations that can be used to derive a highly individualized treatment plan for reducing atherosclerotic risk.

A first aspect of the present invention is a method of determining a patient's coronary artery disease (CAD) risk profile. In one exemplary embodiment, the present invention is a method of determining if an asymptomatic patient with no known history of CAD is at high or low risk of developing CAD, comprising the steps of (i) obtaining a set of risk assessment values for the patient, and (ii) using the risk assessment values to classify the patient as high or low risk.

In another exemplary embodiment, the present invention is a method of determining if an a symptomatic patient with no known history of CAD is at high or low risk for developing CAD, wherein prior to conducting the risk assessment described above, the patient is assessed using coronary CT angiography to determine the level of coronary artery obstruction. If the coronary CT angiography detects no plaque build up the patient is further classified as high or low risk as described above. If the coronary CT angiography does detect obstruction, or does not detect obstruction, but does detect plaque buildup, the patient is classified as high risk without further risk stratification.

In yet another exemplary embodiment, the present invention is a computer implemented method for determining the coronary artery disease risk level of an asymptomatic patient or a symptomatic patient without plaque build-up, the method comprising (i) entering a set of risk assessment values for the patient, (ii) determining a risk level score based on the risk assessment values, and (iii) displaying the risk level score.

In one exemplary embodiment the set of risk assessment values includes, but is not limited to, a genetic predisposition score, a Framingham score, a biomarker analysis score, and a atherosclerosis imaging score.

Once risk level has been assessed, it can be used to assess the appropriate intensity of treatment. A second aspect of the present invention is therefore directed to methods for goal setting for patients with, or at risk of, atherosclerosis, comprising the steps of establishing target goals for one or more of (i) apolipoprotein B (ApoB); (ii) apolipoprotein A (ApoA); (iii) the ratio of ApoB/ApoA; (iv) low density lipoproteins (LDL-C) cholesterol; (v) high density lipoprotein cholesterol (HDL-C); (vi) triglycerides (TG); (vii) Lp(a); and (viii) lipoprotein fractionation.

The goals and goal setting methods of the present invention are described below with reference to tables and flowchart illustrations, which similar to the methods of risk stratification, may be embodied as a computer program product.

A third aspect of the present invention is directed to methods for attaining treatment goals for patients with, or at risk for, atherosclerosis.

In a particular embodiment, the present invention is a method for selecting therapeutic treatment regimens for patients in which available treatments are listed and optionally ranked, while unavailable or rejected treatment regimens (e.g., regimens that would not be effective, or would be dangerous) are not displayed or are assigned a low rank and are indicated to a user as not likely to be efficacious, or not preferred due to patient-specific complicating factors such as drug interaction from concomitant medications.

The treatment selection methods of the present invention are described below with reference to flowchart illustrations. As will be appreciated by one of skill in the art, the goal attainment methods of the present invention may be embodied as a computer program product.

### BRIEF DESCRIPTION OF THE DRAWINGS

FIG. 1. is a logic flow diagram illustrating an exemplary embodiment of a method for determining a patient's coronary artery disease risk level.

FIG. 2. is a logic flow diagram illustrating an exemplary submethod or routine of FIG. 1 for determining a patient's risk level.

FIG. 3 is a logic flow diagram illustrating an exemplary submethod or routine of FIG. 2 for determining a patient's risk level

FIG. 4. is a logic flow diagram illustrating an exemplary submethod or routine of FIG. 2 for determining a patient's risk level

FIG. 5. is a logic flow diagram illustrating an exemplary submethod or routine of FIG. 2 for determining a patient's risk level

FIG. 6. is a logic flow diagram illustrating an exemplary embodiment of a method of attaining therapeutic treatment goals.

FIG. 7. is a logic flow diagram illustrating an exemplary embodiment of a treatment plan for meeting therapeutic treatment goals.

### DETAILED DESCRIPTION

The present invention is directed to methods for atherosclerosis risk reduction including initial risk stratification, goal setting, and goal attainment for patients with, or at risk for, atherosclerosis. The present invention may be embodied in a computer implemented software product, the modules and sub-routines resident on a computer or hand held device, allowing a physician to determine the best strategy for coronary artery disease prevention based on such risk assessment values as Framingham score, genetic predisposition, biomarker levels and atherosclerosis imaging scores. The software product is supported by a backend database containing risk assessment value scores for a patient population of known clinical outcome. This database may then be used in deriving linear classifiers and other means for calculating risk assessment values. The present invention may also further comprise a second database for storing information on patients currently under evaluation in order to monitor their progress and the meeting of various therapeutic goals. The databases may reside in a memory unit, such as a hard drive, of the computer or hand held device, or may be accessed remotely in a distributed computer environment.

In one embodiment, the present invention is directed to a method of screening of individuals which includes, but is not limited to, genetic predisposition, phenotyping, biomarker analysis, and atherosclerotic imaging from which information is recorded in a large-scale, prospective database that allows tracking of goal attainment and resource utilization over time.

In another embodiment, the present invention is directed to a method of risk assessment or stratification for patients with, or at risk for, atherosclerosis. In order to more effectively assess a patient's atherosclerosis risk, the present method utilizes information relating to genetic predisposition, phenotype, biomarkers and atherosclerotic imaging. In a particular embodiment, the method of risk assessment utilizes information relating to family history, Framingham scores, LpPLA2 levels and coronary artery calcium (CAC) imaging.

The risk assessment step is followed by identification and establishment of key therapeutic goals for reducing a patient's risk of atherosclerosis. In order to more effectively assess a patient's risk for atherosclerosis, refined goals are established that include discrete lipid profile targets tailored to a patient's unique genetic and phenotypic background.

Treatment protocols are then designed according to the methods of the present invention to help the patient reach a particular therapeutic goal, again with reference to the patient's unique genetic and phenotypic attributes.

Although the illustrative embodiments will be generally described in the context of computer implemented method comprising program modules running on a general purpose computer, those skill in the art will recognize that the present invention may be implemented in conjunction with operating system programs, or with other types of program modules for other types of computers. Furthermore, those skilled in the art will recognize that the present invention may be implemented in either a stand-alone, or in a distributed computing environment, or both. In a distributed computing environment, program modules may be physically located in different local and remote memory storage devices. Execution of the program modules may occur locally in a stand-alone manner or remotely in a client server manner. Examples of such distributed computing environments include local area networks and the Internet.

The detailed description that follows is represented largely in terms of processes and symbolic representations of operations by conventional computer components, including a processing unit (a processor), memory storage devices, connected display devices, and input devices. Furthermore, these processes and operations may utilize conventional computer components in a heterogeneous distributed computing environment, including remote file servers, computer servers, and memory storage devices. Each of these conventional distributed computing components is accessible by the processor via a communication network

The processes and operations performed by the computer include the manipulation of signals by a processor and the maintenance of these signals within data structures resident in one or more memory storage devices. For the purposes of this discussion, a process is generally conceived to be a sequence of computer-executed steps leading to a desired result. These steps usually require physical manipulations of physical quantities. Usually, though not necessarily, these quantities take the form of electrical, magnetic, or optical signals capable of being stored, transferred, combined, compared, or otherwise manipulated. It is convention for those skilled in the art to refer to representations of these signals as bits, bytes, words, information, elements, symbols, characters, numbers, points, data, entries, objects, images, files, or the like. It should be kept in mind, however, that these and similar terms are associated with appropriate physical quantities for computer operations, and that these terms are merely conventional labels applied to physical quantities that exist within and during operation of the computer.

It should also be understood that manipulations within the computer are often referred to in terms such as creating, adding, calculating, comparing, moving, receiving, determining, identifying, populating, loading, executing, etc. that are often associated with manual operations performed by a human operator. The operations described herein can be machine operations performed in conjunction with various input provided by a human operator or user that interacts with the computer.

In addition, it should be understood that the programs, processes, methods, etc. described herein are not related or limited to any particular computer or apparatus. Rather, various types of general purpose machines, such as laptop computers, personal digital assistants, and netbooks, may be used with the program modules constructed in accordance with the teachings described herein. Similarly, it may prove advantageous to construct a specialized apparatus to perform the method steps described herein by way of dedicated computer systems in specific network architecture with hard-wired logic or programs stored in nonvolatile memory, such as read-only memory.

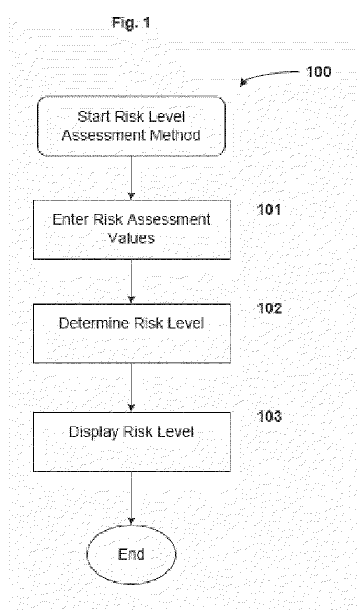

Referring now to FIGS. 1 through 5, these figures illustrate an exemplary logic flow diagrams for assessing a patient's CAD risk profile and determination of therapeutic goals. The logic flow described in FIG. 1, is the core logic or the top-level processing loop of the computer implemented method, and as such may be executed repeatedly.

It is noted that that the logic flow diagram illustrated in FIG. 1 can illustrate a process that occurs after initialization of several of the software components. That is, in the exemplary programming architecture of the present invention, several of the software components or software objects that are required to perform the steps illustrated in FIG. 1 can be initialized or created prior to the process described b FIG. 1. Therefore, one of ordinary skill in the art will recognize that several steps pertaining to initialization of the software objects may not be illustrated.

Certain steps in the process described below must naturally precede others for the present invention to function as described. However, the present invention is not limited to the order of the steps described if such order or sequence does not alter the functionality of the present invention. That is, it is recognized that some steps may be performed before or after other steps or in parallel with other steps without departing from the scope and spirit of the present invention.

Beginning in FIG. 1, the method 100 of assessing the CAD risk level of an asymptomatic patient, or a symptomatic patient without plaque build up, starts by accepting a set of risk assessment values entered using a user interface 101. When applied in the context of a distributed computing environment, the user interface may be in the form of Hypertext Mark-up Language documents (“HTML pages”) which can accept user input of the risk assessment values.

The risk assessment values may comprise, but are not limited to, a genetic predisposition score, a Framingham score, a biomarker analysis score, and an atherosclerosis imaging score.

### Genetic Predisposition Score

The genetic predisposition score includes information on family history as well as the detection of one or more genetic polymorphisms or mutations associated with increased CAD risk. Family history is an important and independent CAD risk factor, especially for early onset disease. Many studies have found a two to three-fold increase in CAD given a first-degree relative with CAD (Slack et al. J. Med Genet 1966, 3:239-237; Friedlander et al. Br Heart J 1985, 53:383-387; Thomas et al. Ann Intern Med. 1955; 42:90-127; Lloyd-Jones et al. JAMA 2004; 291:2204-2211).

The family history evaluation is conducted by interview with the patient. In one embodiment, familial risk for early-onset coronary heart disease (CHD) is limited to first-degree relatives. In a specific embodiment, the patient is considered to have a family history of CAD if one or more of the following symptoms and/or disease states is/are noted: family history of premature CHD (MI or sudden death before age 55 in father or other male first-degree relative, or before age 65 in mother or other female first-degree relative.

Lipoprotein levels are determined by genes that code for proteins that regulate lipoprotein synthesis, interconversions and catabolism. These include the apolipoproteins, the lipoprotein processing proteins and the lipoprotein receptors. There are six major classes of apolipoproteins and several subclasses including: A (apo A-I, apo A-II, apo A-IV, and apo A-V), B (apo B48 and apo B100), C (apo C-I, apo C-II, apo C-III, and apo C-IV), D, E and H. The lipoprocessing proteins include lipoprotein lipase, hepatic triglyceride lipase, lecithin cholesteryl acyltransferase (LCAT) and cholesteryl ester transfer protein. The lipoprotein receptors include: LDL receptor, chylomicron remnant receptor and scavenger receptor.

Mutations in the genes encoding these proteins, which are known, may cause disturbances in lipoprotein metabolism that may lead to disorders including premature atherosclerosis. A particular disease may result from rare single-gene mutations (major gene effects) while another may be due to an accumulation of common mutations in several different genes each having small effect (some with no effect) and unable to cause disease on their own (polymorphisms).

Apo E polymorphisms appear to be importantly associated with variations in lipid and lipoprotein levels. Apo E has three different protein forms: E2, E3 and E4 differing from each other by a single amino acid substitution. Each isoform is encoded by distinct alleles on human chromosome 19. The presence of the E4 isoform is associated with coronary heart disease (Song et al. Ann of Int Med. 2004; 141(2):137-147). E2 is associated with the genetic disorder type III hyperlipoproteinemia and with both increased and decreased risk for atherosclerosis.

Other genetic polymorphisms have also been associated with atherosclerosis. Studies have suggested an association of common polymorphisms in the hepatic lipase gene, including LIPC-480C/T and LIPC-514C/T, with lipid levels and/or risk of CAD. 5-lipoxygenase polymorphisms are though to promote atherosclerosis by increasing leukotriene production within plaques. Genes that regulate the renin angiotensin system may also play a role in developing cardiovascular system disorders. The presence of the “deletion” (D) allele in the angiotensin converting enzyme (ACE) gene is associated with coronary artery disease (Tanriverdi et al. Hea Ves 2007;22(1):1-8).

The polymorphisms can be detected using any suitable commercially available kit or known method in the art including, but not limited to, allele-specific PCR, hybridization with an oligonucleotide probe, DNA sequencing, or enzymatic cleavage.

In one exemplary embodiment, the genetic predisposition score comprises a family history value, an ApoE4 value, and Apo E2 value, a LIPC-480 C/T value, a LIPC-514 C/T value, a 5-lipoxygenase polymorphism value, and a deletion value of angiotensin value.

### Framingham Score

The Framingham Score assesses a patient's risk of developing CAD, taking into account such factors as sex, age, diabetes, smoking, blood pressure, total cholesterol and LDL cholesterol (Wilson, Circulation, 1998, 97:1837-47). Various values are assigned to each of the factors above and the composite score gives an overall assessment of a patients risk of developing CAD over either a two year or ten year time frame.

### Biomarker Analysis

A biomarker analysis score is determined from information gathered relating to levels of circulating serum biomarkers, including, but not limited to, CRP, Lp-PLA2, N-terminal BNP and urinary thromboxane A2. Clinical measurements of biomarkers in serum may be performed by any acceptable method, including ELISA (See generally: Wang et al. Expert Rev. Mol. Diagn 2007;7(6):793-804; Dotsenko et al. Expert Rev Mol Diagn 2007;7(6):693-697).

The assay to measure CRP in CVD risk assessment (highly sensitive CRP or “hsCRP”) is well known (Pearson et al. Circ 2003:107:499-511). HsCRP results should only be used in the absence of overt inflammatory processes, where results greater than 10 mg/L suggest the presence of an acute inflammatory process. Two measurements should be made at least 2 weeks apart. The findings to be interpreted are as follows: Low Risk <1.0 mg/L; Average Risk 1.0 to 3.0 mg/L; High Risk >3.0 mg/L.

In another embodiment, Lp-PLA2 is measured using ELISA (e.g., diaDexus PLAC Test). The assay system utilizes monoclonal anti-Lp-PLA₂ antibodies (2C10) directed against Lp-PLA₂ for solid phase immobilization on the microwell strips. Sample is added to the plate and incubated for 10 minutes at 20-26° C. A second monoclonal anti-Lp-PLA₂ antibody (4B4) labeled with the enzyme horseradish peroxidase (HRP) is then added and reacted with the immobilized antigen at 20-26° C. for 180 minutes, resulting in the Lp-PLA₂ molecules being captured between the solid phase and the enzyme-labeled antibodies. The wells are washed with a supplied buffer to remove any unbound antigen. The substrate, tetramethylbenzidine (TMB), is then added and incubated at 20-26° C. for 20 minutes, resulting in the development of a blue color. Color development is stopped with the addition of Stop Solution, changing the color to yellow. The absorbance of the enzymatic turnover of the substrate is determined using a spectrophotometer at 450 nm and is directly proportional to the concentration of Lp-PLA₂ present. A set of Lp-PLA₂ calibrators is used to plot a standard curve of absorbance versus Lp-PLA₂ concentration from which the Lp-PLA₂ concentration in the test sample can be determined. The expected values are measured in ng/mL. Average value for females is 174 ng/mL (range 5th-95th percentile: 120-342), and the average value for males is 251 (range 5th-95th percentile: 131-376).

Several immunoassays are available for N-terminal proBNP (NT-proBNP) (Clerico et al. Clin Chem 2005;51:445-447).

In one exemplary embodiment, the biomarker analysis score is determined by evaluating one or more biomarker level values selected from the group comprising a HSCRP value, a Lp-PLA-2 value, and a N-terminal proBNP value. In another exemplary embodiment, the biomarker analysis score is determined by evaluating a patient's Lp-PLA-2 value.

### Atherosclerosis Imaging

Information on atherosclerotic risk is collected using imaging tools. These tools may vary and include, without limitation, conventional angiography, computed tomographic angiography, duplex ultrasonography (US) and magnetic resonance (MR) angiography.

In one embodiment, a coronary artery calcium (CAC) score is determined by electron beam computed tomography (EBCT) (See Conti et al. Clin Cardiol 2001;24:755-6). Alternatively, it can be measured by multi-slice computed tomography (MSCT).

In another embodiment, coronary artery CT angiography is performed and information is collected. Unlike coronary artery angiography, which assesses the lumen, coronary artery CT angiography exploits its cross-sectional capability to evaluate the vessel wall. According to this method, x-ray contrast is injected into an arm vein and a CT scanner (a multi-slice scanner) takes multiple images in rapid succession. A computer then reassembles these multiple x-ray cross-sectional slices of the heart to produce two and three-dimensional images of the coronary arteries. These images are called CT angiograms (CTA).

In yet another embodiment, arterial MRI examination is performed and information is collected. High-resolution MRI is noninvasive yet exhibits superior capability for discriminating tissue characteristics compared with other imaging modalities (Yuan et al. Circ 2001; 104:2051-2056).

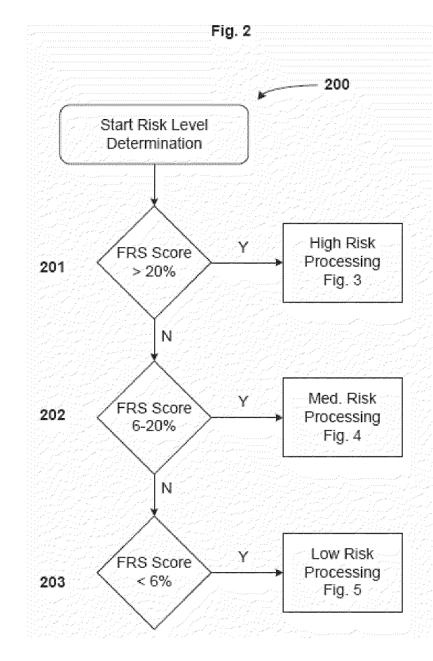

Next, the risk assessment values are used to determine a risk level score at step 102. Further details regarding determination of risk level score are discussed below in reference to FIG. 2 through FIG. 5. In the present method, patients that are known to have CAD, or have no know CAD but have been show by coronary CT angiography to have plaque build-up or obstruction are classified as high risk for purpose of goal setting and attainment. Patients that do not have a previous history of CAD are subjected to a further risk assessment to determine if the patient should be classified as high or low risk. The risk assessment for a patient with no known CAD will vary depending on if the patient was previously classified as asymptomatic or symptomatic without significant plaque build-up or obstruction as detected by coronary CT angiography. The classification as high or low risk according to the methods of the present invention in combination with the assessment of patient's genetic predisposition and phenotype analysis allows a medical practitioner to set key therapeutic goals for the effective management and reduction of a patient's atherosclerosis risk. The risk classification and corresponding therapeutic goals can be displayed on a user display device and exported to a patient's medical record in electronic or hard copy form.

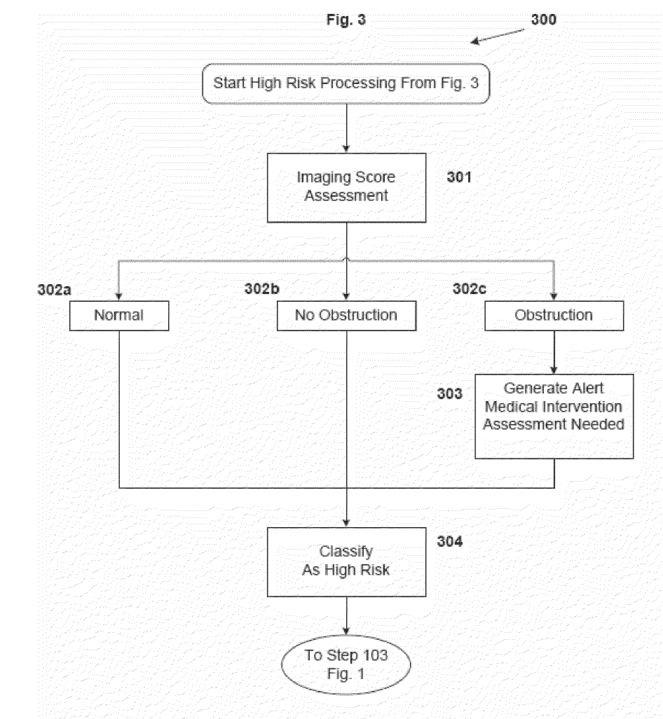

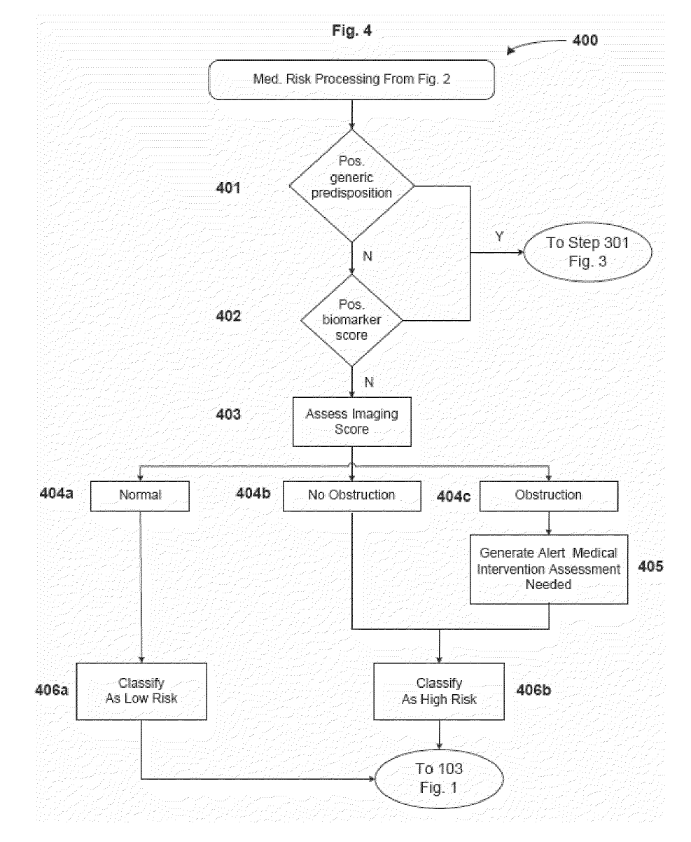

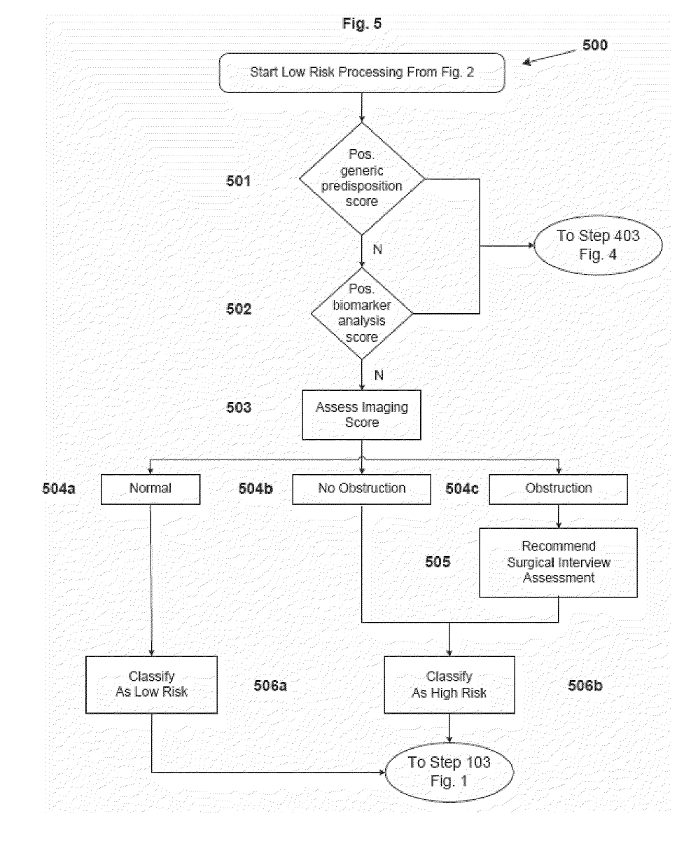

Referring now to FIG. 2, this figure illustrates an exemplary sub-method or routine 200 for determining the risk level score in FIG. 1. A patient's Framingham Score (FRS) is used to assign the patient into a preliminary risk category of high risk, medium risk, or low risk. The factors used to calculate the score include total cholesterol level (mg/dL), HDL cholesterol level (mg/dL), age, sex, systolic blood pressure (mm/Hg), and smoking status. Total cholesterol and HDL values should be the average of at least two measurements obtained from lipoprotein analysis. The blood pressure value used is that obtained at the time of assessment, regardless of whether the person is on antihypertensive therapy (treated hypertension carries residual risk). The designation “smoker” means any cigarette smoking in the past month. A patient is categorized as high risk 201 if the FRS is greater than 20% and further processed as described in more detail in reference to FIG. 3 below. A patient is categorized as medium risk 202 if the FRS is between 6 and 20% and further processed as described in reference to FIG. 4 below. A patient is categorized as low risk 203 if the FRS is less than 6% and further processed as described in reference to FIG. 5 below.

Referring now to FIG. 3, this figure illustrates an exemplary sub-method or routine 300 for further assessing the risk level of a patient categorized in the high preliminary risk category in FIG. 2. Sub-method 300 assesses the patient's atherosclerosis imaging score 301 entered in step 101 of FIG. 1 in the context of the patient's FRS. The atherosclerosis imaging score is used to classify the patient as normal 302a, plaque build-up with no obstruction 302b, and obstructed 302c. In one exemplary embodiment, the atherosclerosis imaging score is derived from conducting a coronary artery calcium scan, which assesses the amount of calcium buildup in the arteries of the heart. Correlative studies indicate that patients with greater amount of coronary calcification are more likely to suffer a coronary event (Budoff and Gul, Vasc Health Risk Manag, 2008, 4(2):315-24). No prior patient interruption of medication is generally required for coronary artery calcium imaging.

When one technique, electron beam computed tomography (EBCT), is used, images are obtained in 100 milliseconds with a scan slice thickness of 3 mm. Thirty to 40 adjacent axial scans are obtained by table incrementation. The scans, which are usually acquired during one or two separate breath-holding sequences, are triggered by the electrocardiographic signal at 80% of the RR interval, near the end of diastole and before atrial contraction, to minimize the effect of cardiac motion. The rapid image acquisition time virtually eliminates motion artifacts from cardiac contraction. The state of the coronary arteries is easily identified by EBCT because the lower CT density of periarterial fat produces marked contrast to blood in the arteries, while the mural calcium is evident because of its high CT density relative to blood. The scanner software allows quantification of calcium area and density. The extent of calcification is measured by means of a calcium score calculated by the computer software on the basis of plaque size and density or as volume of calcified plaque. Other technologies can be used to calculate CAC, including, as examples, fluoroscopy, conventional computed tomography and angiography.

For all age groups, the higher the CAC score, the more coronary disease is present and the greater the likelihood that it may result in an adverse event in the future if left untreated. Fewer than 5% of asymptomatic patients with a CAC score of less than 100 will have an abnormal stress test. If the calcium score is 0, the probability falls to less than 1%. Alternatively, patients with a calcium score of >400 can be expected to have a positive stress test in up to 40% of cases. In low risk scenarios, the CAC score is very likely to be zero or low and unlikely to change patient management.

All patients classified in groups 302a, 302b, and 302c are automatically classified as high risk. However, ff a patient is classified as obstructed 302c, an alert recommending further analysis regarding the immediate need for medical intervention is displayed to the user at step 303. The alert may indicate the need to conduct the following additional test in successive order; exercise MPI, coronary angiography, and percutaneous coronary intervention (PCI) or coronary bypass graft surgery (CABG). The user may bypass the alert or the user may enter whether the previous procedures were conducted and their outcome. This information may then associated with the patients record.

Referring now to FIG. 4, this figure represents a sub-method or subroutine for further assessing the risk level of a patient initially classified as medium risk 400. The method starts by evaluating whether the patient has a positive genetic predisposition score 401. As noted above the genetic predisposition score may derived from a set of genetic predisposition values including, but not limited to, a family history values and one or more polymorphism values.

In one exemplary embodiment, a patient may be considered to have a positive family history value if one or more of the following are noted: one or more family members with premature coronary heart disease defined as myocardial infarction or sudden death before age 55 in father, or other male first-degree relative, or before age 65 in mother or other female first-degree relative. In one exemplary embodiment, the family history value may be assigned a value of 1 for a positive family history and 0 for a negative family history.

In one exemplary embodiment the presence of genetic polymorphisms associated with increased risk of CAD may be given a value of 1 if present and 0 if absent. In another exemplary embodiment the genetic predisposition score may then be calculated as the arithmetic sum of the family history value and all polymorphism values assessed, where a value of one or more indicates a positive genetic predisposition score. Alternatively, a linear classifier may be derived from the database containing risk assessment values for a patient population of known clinical outcome. A separate linear classifier may be derived for family history and each genetic polymorphism assessed, or multivariate analysis may be conducted across all genetic predisposition values to derive a linear classifier that weighs the presence of one allele in the context of a patient's family history and the presence of other relevant polymorphisms using standard multivariate analysis methods know in the art.

If the genetic predisposition score is positive, the medium risk patient is reclassified as high risk and further assessed according to subroutine 300 of FIG. 3.

If the genetic predisposition score is negative or neutral, the biomarker analysis score is evaluated at step 402. As noted above the biomarker analysis score may be derived from a set of biomarker level values including, but not limited to, CRP, LpPLA2, N-terminal BNP and urinary thromboxane A2. The determination of whether biomarker level values are elevated may be conducted according to standard method in the art. For example, CRP value above 1.0 mg/L is indicative of increased risk of CAD. Lp-PLA2 values are considered elevated when above 174 ng/mL in females and 251 ng/mL in males. As in the genetic predisposition score, the bioanylsis value can be assigned a value of 1 if the biomarker level evaluated is elevated and 0 if it is normal. The biomarker analysis score can the be calculated as the arithmetic sum of the biomarker analysis values, with a value greater than zero indicative of a positive biomarker analysis score. Alternatively, a linear classifier may be derived from the database containing risk assessment values for a patient population of known clinical outcomes. A separate linear classifier may be derived for each biomarker assessed, or multivariate analysis may be conducted across all biomarkers to generate a linear classifier that weighs one biomarker analysis value in the context of all other biomarker values assessed using standard methods known in the art. In one exemplary embodiment the biomarker analysis score is derived by determining whether a patient's Lp-PLA-2 level is elevated.

If the biomarker analysis score is positive, the medium risk patient is reclassified a high risk and further assessed according to subroutine 300 of FIG. 3.

If the biomarker analysis score is negative or neutral, the patient's atherosclerosis imaging score is analyzed 403. The atherosclerosis imaging score is used to classify the patient as normal 404a, plaque build up with no obstruction 404b, or obstructed 404c. As discussed in reference to step 301 of FIG. 3, the atherosclerosis imaging score may be derived from a coronary calcium scan. Patients classified as normal in 404a are given a final classification as low risk at step 406a. Patient's classified as non-obstructed in 404b are given a final classification of high risk 406b. If a patient is classified as obstructed 406a, an alert recommending further analysis to determine if immediate medical intervention is need is displayed to the user at step 405. The alert may indicate the need to conduct the following additional test in successive order; exercise MPI, coronary angiography, and PI or CABG. The user may elect to bypass the alert, or the user may enter whether the previous procedures were conducted and their outcome. This information may then be associated with the patients record. The patient is then given a final classification of high risk at sep 406b.

Referring now to FIG. 5, this figure presents a sub-routine or method for further assessing a patient initially classified as low risk. Steps 501 through 506 correspond substantially to steps 401 through 406 described above in reference to FIG. 4. At step 501, if the genetic predisposition score is positive the patient is reclassified as medium risk and further processed beginning at step 403 of FIG. 4. At step 502, if the biomarker analysis score is positive, the patient is reclassified as medium risk and further processed beginning at step 403 of FIG. 4.

### Therapeutic Goals

In contrast to current guidelines, which do not take into consideration a patient's specific genetic and metabolic characteristics, the present invention utilizes the initial screening and risk stratification steps to determine key therapeutic goals that more effectively reduce a patient's atherosclerosis risk. The present invention can be used to establish therapeutic target goals tailored to a patient's specific risk level, the risk level in turn reflecting a patient's unique genetic and phenotypic background. In one exemplary embodiment, a high risk and low risk target therapeutic goal is set for one or more of the following therapeutic targets selected from the group comprising ApoB, ApoA, ApoB/ApoA, LDL-C, HDL-C, TG, mean LDL particle size, HDL2, Lp(a), and CRP. The appropriate therapeutic goal for each risk level can be set initially based on current standards of care as readily determined by one or ordinary skill in the art. The database containing risk assessment values of a patient population of known clinical outcome can be used to further test correlations between a given genetic or phenotypic profile and the appropriate therapeutic target values. Appropriate therapeutic goals can be assessed using such factors as, but not limited to, the percentage of patient's of particular genetic or phenotypic background that successfully attain the set therapeutic target. The present invention determines therapeutic goals for high and low risk patients for the following: ApoB, LDL-C, ApoA, HDL-C, ApoB/ApoA, triglycerides, Lp(a), and lipoprotein fractionation. An exemplary, non-limiting set of therapeutic goals for high and low risk patients are provided in Table 1.

TABLE 1

| Therapeutic Target | High Risk | Low risk |
|---|---|---|
| ApoB | <60 | <100 |
| ApoA | >140 | >100 |
| ApoB/ApoA | <0.85 | <1.1 |
| LDL-C | <60 | <100-130 |
| HDL-C | >60 | >50 |
| TG | <100 | <150 |
| Mean LDL particle size | >263 | >257 |
| HDL2 | >30 | >25 |
| Lp(a) | Intensify ApoB tx | Intensify ApoB tx |
| CRP | <1.0 | <1.0 |
| Lp-PLA2 | >235 ng/mL | <235 ng/mL |
| Fasting Glucose | >=126 mg/dL | <=99 mg/dL |
| HbA1c | >=7 | <6 |
| Fasting Insulin | >10 | <7 |
| SBP | <120 | <130 |
| DBP | <80 | <85 |

The therapeutic goals may be incorporated along with the appropriate risk classification on a display device at step 103 of FIG. 1. The therapeutic goals may then be exported to the patient's record in electronic or hard copy format.

In one embodiment, the present invention provides a exemplary step-wise treatment plan for evaluating and meeting the above therapeutic goals. In contrast to current treatment guidelines, the present invention seeks to minimize the number of drugs and office visits required to effectively reduce a patient's atherosclerosis risk as well as further reduce the risk itself all via an individualized approach.

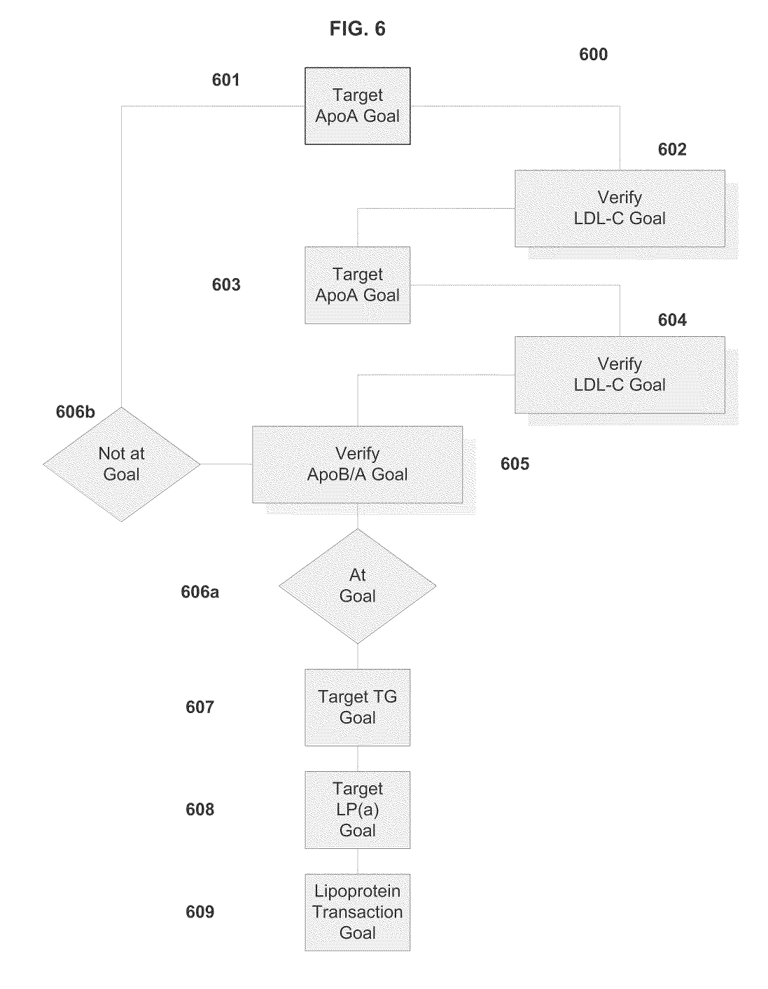

Referring to FIG. 6, this figure shows an exemplary embodiment of the method of evaluating and meeting the goal 600 comprising: (i) reaching a target ApoB goal 601; (ii) verifying an LDL-C Goal 602; (iii) reaching a target ApoA goal 603; (iv) verifying a target HDL-C goal 604; (v) verifying an ApoB/ApoA goal 605; (vi) if the ApoB/ApoA goal has not been reached, repeating the method beginning with step (i) until it has 606b; (vii) reaching a target TG goal 607; (viii) reaching a target Lp(a) goal 608; and (ix) reaching one or more lipoprotein fractionation goals 609.

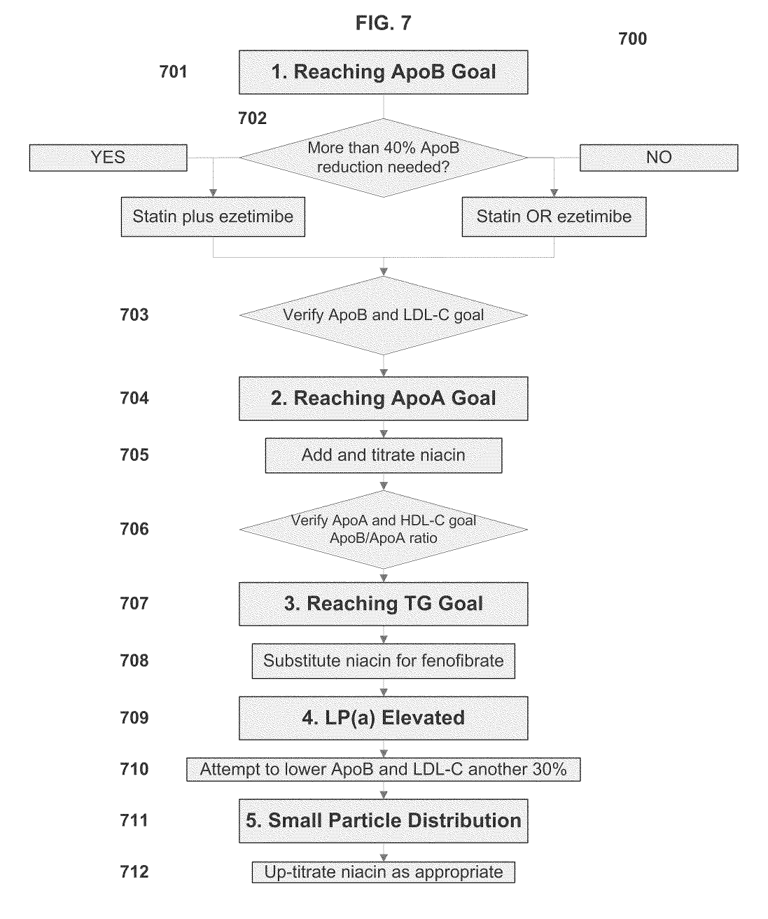

Referring now to FIG. 7, this figure shows an exemplary therapeutic algorithm of the present invention 700. As described therein, the method involves (i) reaching an ApoB goal 701; (ii) determining if more than 40% reduction in ApoB is required 702; (iii) administering statin and/or ezetimibe depending on conclusion of part (ii); (iv) verifying the ApoB and LDL-C goal 703; (v) reaching an ApoA goal 704; (vi) adding and titrating niacin 705; (vii) verifying ApoA goal, HDL-C goal, and ApoB/ApoA ratio 706; (viii) reaching a TG goal 707; (ix) substituting niacin for fenofibrate 708; (x) determining if Lp(a) is elevated 709; (xi) attempting to lower ApoB and LDL-C another 30% 710; (xii) reaching a small particle distribution goal 711; (xiii) and up-titrate niacin as appropriate 712.

Certain steps regarding the methods of evaluating meeting therapeutic goals and the associate algorithms described above must naturally precede others for the present invention to function as described. However, as readily discernable by one of ordinary skill in the art, the present invention is not limited to the order of steps described if such order or sequence does not alter the functionality of the present invention. That is, it will be appreciated by one of ordinary skill in the art that some steps may be performed before or after other steps or in conjunction with other steps without departing from the scope and spirit of the present invention.

All patents and patent publications referred to herein are hereby incorporated by reference.

Certain modifications and improvements will occur to those skilled in the art upon a reading of the foregoing description. It should be understood that all such modifications and improvements have been deleted herein for the sake of conciseness and readability but are properly within the scope of the following claims.

1. A computer implemented method for determining a coronary artery disease risk level for an asymptomatic patient comprising:
a) entering a set of risk assessment values for the patient;
b) determine a risk level score; and
c) displaying the risk level.

2. The method of claim 1, further comprising the steps of:
a) deriving a set of therapeutic goals based on the risk level assessment; and
b) displaying the set of therapeutic goals.

3. The method of claim 1, wherein the set of risk assessment values are selected from the group comprising a genetic predisposition score, a Framingham score, a biomarker analysis score, and an atherosclerosis imaging score.

4. The method of claim 3, wherein the genetic predisposition score comprises a set of values selected from the group comprising; a family history score, an ApoE4 score, an ApoE2 score, a LIPC-480 C/T score, a LIPC-514 C/T score, a 5-lipooxygenase polymorphism score, a deletion allele of angiotensin score.

5. The method of claim 3, wherein the biomarker analysis score comprises a set of biomarker level values selected from the group comprising; a HSCRP value, a Lp-PLA-2 value, a N-terminal proBNP.

6. The method of claim 3, wherein the atherosclerosis imaging score comprises a set of atherosclerosis imaging values derived using an imaging tool selected from the group comprising: conventional angiography, computed tomographic angiography, duplex ultrasonography, magnetic resonance angiography, and electron beam computed tomography.

7. The method of claim 3, wherein the step of correlating the risk assessment values comprises:
assigning the patient in a preliminary risk category of high, medium, or low risk based on a Framingham score;
deriving a genetic predisposition score by correlating the genetic predisposition values with a database containing risk assessment values for a patient population with known clinical outcome, wherein a positive genetic predisposition score indicates an increased risk of coronary artery disease and a negative genetic predisposition score indicates a decreased risk of coronary artery disease;
deriving a biomarker analysis score by correlating the biomarker level values with the database, wherein a positive biomarker analysis score indicates an increased risk of coronary artery disease and a negative biomarker analysis score indicates a decreased risk of coronary artery disease;
reassigning a patient in the medium preliminary risk category with a positive genetic predisposition or positive biomarker analysis score to the high risk category and reassigning a patient in the low preliminary risk category with a positive genetic predisposition score or positive biomarker analysis score to the medium risk category;
assigning patients in the high preliminary risk level to the final high risk level; and
assigning patients in the medium or low preliminary risk level to a final high risk level or low risk level based on the atherosclerosis imaging score, wherein a patient with a negative atherosclerosis imaging score is assigned to the final risk level of low and a patient with a neutral or positive atherosclerosis imaging score is assigned to the final risk level of high.

8. The method of claim 7, wherein deriving the genetic predisposition score comprises evaluating the genetic predisposition values with a linear classifier derived from the risk assessment values in the database.

9. The method of claim 7, wherein deriving the biomarker analysis score comprises evaluating the biomarker level values with a linear classifier derived from the risk assessment values in the database.

10. The method of claim 2 wherein the therapeutic goal values are selected from the group comprising; an ApoB value, a LDL-C value, an ApoA value, a HDL-C value, an ApoB/ApoA ratio value, a triglyceride goal, a Lp(a) goal, and a small particle distribution goal.
